(19) United States
(12) Patent Application Publication
(10) Pub. No.: US 2016/0160532 A1
(43) Pub. Date: Jun. 9, 2016

(54) Security Locking Device for Enclosure Covers

(71) Applicant: Lockdown, Inc., Conyers, GA (US)

(72) Inventors: Gustavo Patino, Norcross, GA (US); James E. Tibbs, JR., Marietta, GA (US)

(73) Assignee: Lockdown, Inc., Conyers, GA (US)

(21) Appl. No.: 14/883,030

(22) Filed: Oct. 14, 2015

Related U.S. Application Data
(60) Provisional application No. 62/063,547, filed on Oct. 14, 2014.

(51) Int. Cl. E05B 65/00; E02D 29/14; E05B 9/08; E05B 19/00; E05B 15/00; E05B 9/04

(52) U.S. Cl. CPC E05B 65/006; E05B 15/0006; E05B 9/04; E05B 9/084; E05B 19/00; E02D 29/1427

(57) ABSTRACT

An apparatus for locking an enclosure cover, such as a manhole cover or enclosure lid, in seated engagement on its enclosure frame, includes a lock housing positioned within a lock aperture extending perpendicularly through the top surface of the enclosure cover. A reciprocating, manual throw bolt is inserted within an aperture extending laterally within the enclosure cover between the lock aperture and the side of the enclosure cover for releasable engagement into a receiving aperture within the enclosure frame. When inserted, the lock housing maintains the manual throw bolt in locking engagement with the enclosure frame. The lock housing includes a cylinder cam lock for releasably locking the lock housing in place within the lock aperture. The cylinder cam lock uses conventional keys that can be mastered or zoned. The locking apparatus can be retrofit into existing enclosure covers or included during initial manufacture of such covers.

### CROSS REFERENCE TO RELATED APPLICATION

This application claims priority benefit under 35 U.S.C. §119(e) of U.S. Provisional Patent Application No. 62/063,547, entitled “Security Locking Device,” filed Oct. 14, 2014, which is incorporated herein by reference in its entirety.

### FIELD OF THE INVENTION

The present technology relates generally to locking devices and, more particularly, to security locking devices used to lock and secure enclosure covers, such as manhole covers, hand hole lids, utility doors or access panels, and any other publicly-accessible enclosure where theft, vandalism, and any other unauthorized access or interference need to be deterred.

### BACKGROUND OF THE PRESENT INVENTION

There are many security locking devices designed for locking and securing non-metallic enclosure covers to an enclosure frame. Such covers include composite manhole covers, hand hole lids, utility access panels or doors, and the like. These security locking devices are designed to prevent theft of the cover, to deter copper theft, to prevent acts of vandalism, and to reduce risk of unauthorized access to protected areas and equipment. Typical locking mechanisms include piston-type locks, locks with spring loaded bolts, cam locks to secure the lid to the frame, as well as locks that utilize augers, levers, and paddles.

Most of these traditional locks for enclosure covers use a low-security handle, wrench, lever, or large locking tool that is made specifically for opening that lock. Such tools are typically too large and unwieldy to fit on a key ring or in a pocket. Most of these locking tools have a limited number of configurations, which do not provide advanced security solutions such as zoning, key control, or quick key replacement.

Often, these types of traditional locking tools only have a single configuration, which means that only one tool/key configuration is used to unlock every lock manufactured by that provider. Thus, if that manufacturer's locking tool is stolen or replicated, all of the covers using that one tool/key configuration are exposed to the threat of unauthorized entry and malicious intent. Therefore, if that tool/key configuration is compromised, every cover and lid using that tool/key configuration has to be replaced to eliminate the exposure. Yet further, many manufacturer's tool/key configuration can actually be opened with tools and hardware readily available for public purchase.

Typical uses for these types of locking mechanisms include composite manhole covers and lids, composite or light-concrete hand hole covers or lids, utility doors and panels, and the like—although there are many implementations in which the present locking device and system can be used to advantage. Most of the locks presently available in the marketplace are designed for a specific cover or use and, thus, are integrated into the manufacturing process for that specific cover or lid at a factory or assembly facility.

Presently, there is no solution for locking an enclosure cover or lid with a standard-sized key with custom key codes and the ability to zone and master key, that has the ability to retrofit an existing cover or lid, and that does not require use of springs, gears, or other moving parts that can deteriorate, seize, and corrode over time due to environmental exposure.

There is a thus a need for a security locking that can be used to lock or secure any lid, cover, door, or access panel of sufficient depth with a standard-sized key that can be customized, zoned and mastered, and retrofit into an existing lid with minimal alteration of the cover and frame. There is a further need for a security lock that can be replaced without changing the cover.

There is a further need for a security lock that is easy to install both with initial construction or retrofit installations. For retrofit installations, there is a need for a security lock that can be installed with minimal required modifications to the enclosure and cover and that can be accomplished easily in the field.

There is a further need a security lock that provides keyed access to a manhole, hand-hole, or utility-type enclosure while deterring unauthorized access to critical areas, components, copper, and cabling found therein. Further, there is a need for a security lock that not only keeps an enclosure cover in place but that deters theft of the cover itself, as most composite covers have no scrap value.

The technology and improvements described herein provide an exemplary device, system, and combination of components, as described and shown in greater detail hereinafter, that address and teach one or more of the above-referenced capabilities, needs, and features that are useful for a variety of purposes as described, taught, and suggested herein in greater detail.

### SUMMARY OF THE PRESENT TECHNOLOGY

The present technology relates generally to locking devices and, more particularly, to security locking devices used to lock and secure enclosure covers, such as manhole covers, hand hole lids, utility doors or access panels, and any other publicly-accessible enclosure where security, theft, vandalism, or terrorist acts might be a problem.

The present invention provides a keyed security locking device with a standard sized key available with customizable key codes constructed using a lock housing and integrated security bolts, which allows manual movement of a bolt to secure an enclosure cover or lid to the frame or enclosure itself and deters entry and access into the enclosure.

A first aspect of the technology disclosed herein includes a locking apparatus for use with an enclosure cover, the enclosure cover adapted for seated engagement on an enclosure frame, the enclosure cover having a generally planar top surface, a generally planar bottom surface parallel to and disposed a fixed distance h from the top surface, the enclosure cover having a peripheral edge extending around the outer side of the enclosure cover between the top and bottom surface, the enclosure cover having a lock aperture extending perpendicularly through the top surface near an edge of the enclosure cover and a bar aperture extending laterally from the peripheral edge and into the lock aperture, the enclosure frame having a top ridge forming an opening for receipt of the enclosure cover, a support ledge disposed within the enclosure the distance h from the top ridge, the opening through the support ledge being smaller than the opening formed by the top ridge, the top ridge and the support ledge connected by a side member extending therebetween, a bar receiving aperture formed within the side member, so that when in seated engagement the outer edge of the bottom surface of the enclosure cover rests on the support ledge and the lock aperture of the enclosure cover is aligned with the bar receiving aperture in the side member of the enclosure frame, the locking apparatus comprising: a lock housing shaped to fit within the lock aperture; a mounting post connected to the enclosure cover and having a portion extending a fixed distance within the lock aperture, the portion of the mounting post extending within the lock aperture having an end, the lock housing having a first mounting indent on one side thereof for engagement with the end of the mounting post when the lock housing is inserted within the lock aperture; a manual throw bolt inserted within the bar aperture, the manual throw bolt having a shaft extending between the peripheral edge of the enclosure cover and the end of the mounting post within the lock aperture, the shaft having one end extending within the lock aperture, wherein, when the lock housing is inserted within the lock aperture, the manual throw bolt is displaced substantially out of the lock aperture and the other end of the shaft extends into the bar receiving aperture of the enclosure frame, the lock housing having a second mounting indent on the side opposed to the first mounting indent for engagement with the one end of the shaft of the manual throw bolt when the lock housing is inserted within the lock aperture; and a cylinder cam lock mounted within the lock housing, the cam lock having a key hole for receipt of a key configured for use with the cylinder cam lock, the key hole positioned on top of the cylindrical cam lock and accessible through the top surface of the enclosure cover, the cam lock having a cam shaft extending longitudinally through and beyond a bottom surface of the lock housing, a cam plate attached to the end of the cam shaft extending beyond the bottom surface of the lock housing, the cam shaft and cam plate rotatable between a locked position and an unlocked position in response to rotation of the key in the key hole, wherein, when in the locked position, the cam plate is positioned below the one end of the shaft of the manual throw bolt, thereby preventing the lock housing from being removed from the lock aperture, which maintains the other end of the shaft in locking engagement within the bar receiving aperture of the enclosure frame, which prevents the edge of the enclosure cover from being lifted from the enclosure frame.

In a feature, the lock aperture extends through the bottom surface of the enclosure cover. Preferably, engagement of the first mounting indent on the end of the mounting post and engagement of the second mounting indent on the one end of the shaft of the manual throw bolt prevents the lock housing from being forced too far into the lock aperture.

In another feature, the first and second mounting indents of the lock housing are shaped to mate, respectively, with the end of the mounting post and the one end of the shaft of the manual throw bolt. Preferably, the first and second mounting indents of the lock housing are rounded or saddle-shaped.

In one embodiment, the lock aperture and the lock housing are cylindrical. In other embodiments, the lock aperture and the lock housing are non-cylindrical.

In a further feature, the one end of the manual throw bolt is a removable plate. The plate can be screwed or threaded onto the one end or otherwise thereto. Preferably, the edge of the plate is shaped to mate with the second mounting indent of the lock housing.

In one embodiment, the cylindrical cam lock is removably mounted within the lock housing and held in place using a set screw. In another embodiment, the cylindrical cam lock is fixedly mounted within the lock housing.

In another feature, when the cam plate is in the unlocked position, the cam plate is no longer positioned below the one end of the shaft of the manual throw bolt thereby enabling the lock housing to be removed from the lock aperture and enabling the shaft of the manual throw bolt to be withdrawn from the bar receiving aperture of the enclosure frame thereby enabling the enclosure cover to be lifted from the enclosure frame.

In yet a further feature, a cap is placed within the top of the lock housing to cover and protect the key hole and top portion of the cylinder cam lock. Preferably, the top of the lock housing and the cap are flush with the top surface of the enclosure cover. The cap can be of any suitable type, such as a threaded cap that can be tightened with a wrench and having a plug for insertion in the wrench hole or merely a threaded cap that can be tightened with a screw driver.

Preferably, the key used with the cylinder cam lock is a standard-sized door key rather than a custom or unique key designed solely for use with one specific type of lock. Yet further, the cylinder cam lock is preferably configured for use with a zoned or master key so that it can be easily changed or replaced if damaged or if the original key is lost or stolen.

Preferably, the enclosure cover is further engaged with or attached to the enclosure frame on the opposed edge of the enclosure cover opposite the lock aperture. In one embodiment, the enclosure cover is engaged with the enclosure frame using a positioning bar extending laterally from the peripheral edge of the enclosure cover and into a positioning bar aperture formed within the enclosure frame. In another embodiment, the enclosure cover is engaged with or attached to the enclosure frame using a hinge. In yet a further embodiment, the enclosure cover is engaged with the enclosure frame using a second manual throw bolt locked using a second cylinder cam lock inserted into a second lock aperture.

Preferably, the bar aperture is positioned a height x above the bottom surface of the enclosure cover and the bar receiving aperture is formed within the side member of the enclosure frame at the corresponding height x above the support ledge.

A second aspect of the technology disclosed herein includes an integrated enclosure cover and locking apparatus, the enclosure cover adapted for seated engagement on an enclosure frame, the enclosure frame having a top ridge forming an opening for receipt of the enclosure cover, a support ledge disposed within the enclosure a distance h from the top ridge, the opening through the support ledge being smaller than the opening formed by the top ridge, the top ridge and the support ledge connected by a side member extending therebetween, the enclosure frame further including a bar receiving aperture formed within the side member, the integrated enclosure cover and locking apparatus comprising: an enclosure cover housing, the enclosure cover housing having a generally planar top surface, a generally planar bottom surface parallel to and disposed a fixed distance h from the top surface, and a peripheral edge extending around the outer side of the enclosure cover between the top and bottom surface, the enclosure cover housing having a lock aperture extending perpendicularly through the top surface near an edge of the enclosure cover housing and a bar aperture extending laterally within the enclosure cover housing from the peripheral edge and into the lock aperture, the enclosure cover housing shaped so that, when in seated engagement with the enclosure frame, the outer edge of the bottom surface of the enclosure cover housing rests on the support ledge and the lock aperture is aligned with the bar receiving aperture in the side member of the enclosure frame; a lock housing shaped to fit within the lock aperture; a mounting post connected to the enclosure cover housing and having a portion extending a fixed distance within the lock aperture, the portion of the mounting post extending within the lock aperture having an end, the lock housing having a first mounting indent on one side thereof for engagement with the end of the mounting post when the lock housing is inserted within the lock aperture; a manual throw bolt inserted within the bar aperture, the manual throw bolt having a shaft extending between the peripheral edge of the enclosure cover housing and the end of the mounting post within the lock aperture, the shaft having one end extending within the lock aperture, wherein, when the lock housing is inserted within the lock aperture, the manual throw bolt is displaced substantially out of the lock aperture and the other end of the shaft extends into the bar receiving aperture of the enclosure frame, the lock housing having a second mounting indent on the side opposed to the first mounting indent for engagement with the one end of the shaft of the manual throw bolt when the lock housing is inserted within the lock aperture; and a cylinder cam lock mounted within the lock housing, the cam lock having a key hole for receipt of a key configured for use with the cylinder cam lock, the key hole positioned on top of the cylindrical cam lock and accessible through the top surface of the enclosure cover housing, the cam lock having a cam shaft extending longitudinally through and beyond a bottom surface of the lock housing, a cam plate attached to the end of the cam shaft extending beyond the bottom surface of the lock housing, the cam shaft and cam plate rotatable between a locked position and an unlocked position in response to rotation of the key in the key hole, wherein, when in the locked position, the cam plate is positioned below the one end of the shaft of the manual throw bolt, thereby preventing the lock housing from being removed from the lock aperture, which maintains the other end of the shaft in locking engagement within the bar receiving aperture of the enclosure frame, which prevents the edge of the enclosure cover housing from being lifted from the enclosure frame.

In a feature, the lock aperture extends through the bottom surface of the enclosure cover housing. Preferably, engagement of the first mounting indent on the end of the mounting post and engagement of the second mounting indent on the one end of the shaft of the manual throw bolt prevents the lock housing from being forced too far into the lock aperture.

In another feature, the first and second mounting indents of the lock housing are shaped to mate, respectively, with the end of the mounting post and the one end of the shaft of the manual throw bolt. Preferably, the first and second mounting indents of the lock housing are rounded or saddle-shaped.

In one embodiment, the lock aperture and the lock housing are cylindrical. In other embodiments, the lock aperture and the lock housing are non-cylindrical.

In a further feature, the one end of the manual throw bolt is a removable plate. The plate can be screwed or threaded onto the one end or otherwise thereto. Preferably, the edge of the plate is shaped to mate with the second mounting indent of the lock housing.

In one embodiment, the cylindrical cam lock is removably mounted within the lock housing and held in place using a set screw. In another embodiment, the cylindrical cam lock is fixedly mounted within the lock housing.

In another feature, when the cam plate is in the unlocked position, the cam plate is no longer positioned below the one end of the shaft of the manual throw bolt thereby enabling the lock housing to be removed from the lock aperture and enabling the shaft of the manual throw bolt to be withdrawn from the bar receiving aperture of the enclosure frame thereby enabling the enclosure cover housing to be lifted from the enclosure frame.

In yet a further feature, a cap is placed within the top of the lock housing to cover and protect the key hole and top portion of the cylinder cam lock. Preferably, the top of the lock housing and the cap are flush with the top surface of the enclosure cover housing. The cap can be of any suitable type, such as a threaded cap that can be tightened with a wrench and having a plug for insertion in the wrench hole or merely a threaded cap that can be tightened with a screw driver.

Preferably, the key used with the cylinder cam lock is a standard-sized door key rather than a custom or unique key designed solely for use with one specific type of lock. Yet further, the cylinder cam lock is preferably configured for use with a zoned or master key so that it can be easily changed or replaced if damaged or if the original key is lost or stolen.

Preferably, the enclosure cover housing is further engaged with or attached to the enclosure frame on the opposed edge of the enclosure cover housing opposite the lock aperture. In one embodiment, the enclosure cover housing is engaged with the enclosure frame using a positioning bar extending laterally from the peripheral edge of the enclosure cover housing and into a positioning bar aperture formed within the enclosure frame. In another embodiment, the enclosure cover housing is engaged with or attached to the enclosure frame using a hinge. In yet a further embodiment, the enclosure cover housing is engaged with the enclosure frame using a second manual throw bolt locked using a second cylinder cam lock inserted into a second lock aperture.

Preferably, the bar aperture is positioned a height x above the bottom surface of the enclosure cover housing and the bar receiving aperture is formed within the side member of the enclosure frame at the corresponding height x above the support ledge.

The above aspects, features, elements, components and embodiments as well as additional features and aspects of the technology, systems, and methods described herein, or components or portions thereof, are disclosed herein or will become apparent from the following description of preferred embodiments thereof.

This summary is provided to introduce a selection of aspects and concepts in a simplified form that are further described below in the detailed description. This summary is not necessarily intended to identify all key or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIG. 1 illustrates a perspective view of one implementation of the present invention in which a security locking device is used with a composite manhole cover and frame;

FIG. 2 illustrates a perspective view of another implementation of the present invention in which a security locking device is used with a rectangular hand-hole cover and associated enclosure;

FIG. 3A illustrates an exploded view of a first embodiment of the security locking device described herein;

FIG. 3B illustrates an exploded view of a second embodiment of the security locking device described herein;

FIG. 4A illustrates a rotated and exploded view of the security locking device shown in FIG. 3A;

FIG. 4B illustrates a rotated and exploded view of the security locking device shown in FIG. 3B;

FIG. 5 illustrates a top view of the first or second embodiment of the security locking device used in conjunction with the implementation shown in FIG. 1;

FIG. 6A illustrates a cross-section view of the first embodiment of the security locking device when installed in a locking configuration;

FIG. 6B illustrates a cross-section view of the second embodiment of the security locking device when installed in a locking configuration;

FIG. 7A illustrates a cross-section view of the first embodiment of the security locking device when in an unlocked and disengaged configuration; and

FIG. 7B illustrates a cross-section view of the second embodiment of the security locking device when in an unlocked and disengaged configuration.

### DETAILED DESCRIPTION OF PREFERRED EMBODIMENTS

Before being disclosed and described in greater detail hereinafter, it is to be understood that the present technologies, systems, devices, and methods are not limited to specific devices, materials, shapes, methods, components, or particular implementations. It is also to be understood that the terminology used herein is for the purpose of describing particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

Disclosed herein are components that can be used to perform the herein described technologies, systems, devices, and methods. These and other components are disclosed herein, and it is understood that when combinations, subsets, interactions, groups, etc. of these components are disclosed that while specific reference to each various individual and collective combinations and permutation of these may not be explicitly disclosed, each is specifically contemplated and described herein, for all technologies, methods, devices, and systems. This applies to all aspects and components of this specification including, but not limited to, steps in disclosed methods. Thus, if there are a variety of additional steps that can be performed, it is understood that each of the additional steps can be performed with any specific embodiment or combination of embodiments of the disclosed technologies, methods, devices, and systems.

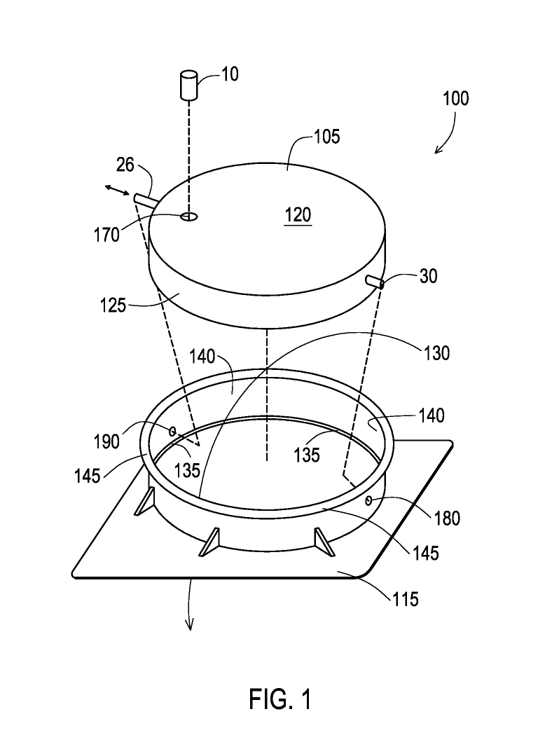

Turning now to the drawings, FIG. 1 illustrates a first embodiment 100 of the present invention in which a security locking device 10 is used to lock a composite manhole cover 105 to its frame 115. The manhole cover 105 has a generally planar top surface 120, an underneath or bottom surface (not visible) spaced from the top surface and a peripheral edge portion 125. The manhole cover 105 is shown above and disengaged from the manhole frame 115, but is seatable on the manhole frame 115 in order to cover a manhole opening 130. In the seated position, the top surface 120 of the manhole cover 105 is accessible from outside the manhole 130, the bottom surface is disposed within the manhole 130, and its peripheral edge portion 125 engages a manhole cover support surface 135 that forms a ledge along the interior of the manhole frame 115. The manhole frame 115 further includes an exposed rim 145 that surrounds the outer edge of the top surface of the manhole cover 120. Between the rim 145 and the manhole cover support surface 135 is a side surface 140 of the manhole frame 115 that is designed to surround the peripheral edge portion 125 of the manhole cover 105. The height of the side surface 140 and the peripheral edge portion 125 are substantially the same so that, when seated and engaged, the top surface 120 of the cover 105 is substantially flush with the rim 145 of the manhole frame 115. Although shown as circular-shaped, it will be understood that the manhole cover 105 and frame 115 can be of any suitable shape.

In accordance with the present invention, the manhole cover 105 includes a lock aperture 170 in the top surface 120 for receiving the security locking device 10. The aperture 170 preferably extends perpendicularly through the cover 105 and through the bottom surface; however, the aperture only needs to be deep enough to fully receive the security locking device 10 therein and below the top surface 120. In a preferred embodiment, the manhole cover 105 preferably includes at least one fixed locator bar 30 that extends laterally from the peripheral edge portion 125 for insertion into a corresponding aperture 180 in the manhole frame 115. If the manhole cover 105 is hinged to the frame 115, then the fixed locator bar 30 is not needed. The manhole cover 105 also includes a manual throw bolt 26 that fits and moves within an aperture that extends laterally within the cover 105 through the peripheral edge portion 125 and into the lock aperture 170. In a preferred embodiment, the fixed locator bar 30 is positioned on the opposed side of the cover 105 from the manual throw bolt 26.

As will be described in greater detail hereinafter, the manual throw bolt 26 is designed to engage and fit within aperture 190 in the frame 115 when the cover 105 is in its seated position on the frame 115 and when the security locking device 10 is installed within the locking aperture 170. When the security locking device 10 is not installed within the locking aperture 170, the manual throw bolt 26 is designed to reciprocate or slide back into the locking aperture 170 space and, thus, to disengage from the aperture 190 in the frame 115 so that the cover 105 is no longer locked to the frame 115 and can be lifted and removed from seated engagement with the frame 115.

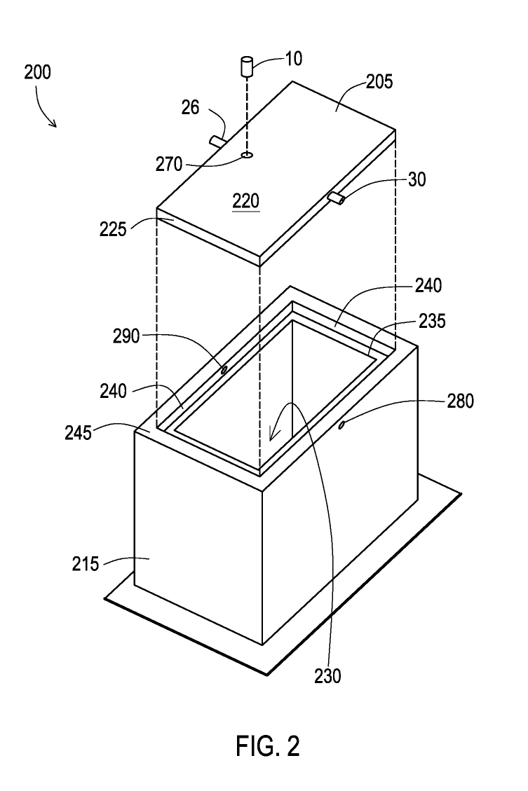

FIG. 2 illustrates a second embodiment 200 of the present invention in which a security locking device 10 is used to lock a hand hole lid 205 to the frame of a hand hole enclosure 215. The hand hole cover 205 has a generally planar top surface 220, an underneath or bottom surface (not visible) spaced from the top surface and a peripheral edge portion 225. The hand hole cover 205 is shown above and disengaged from the hand hole enclosure 215, but is seatable on the hand hole enclosure 215 in order to cover the interior space 230 inside the enclosure 215. In the seated position, the top surface 220 of the hand hole cover 205 is accessible from outside the enclosure 215, the bottom surface is disposed within the enclosure 215, and its peripheral edge portion 225 engages a support surface 235 that forms a ledge around the top interior of the enclosure 215. The enclosure 215 further includes an exposed rim 245 that surrounds the outer edge of the top surface 220 of the hand hole cover 205. Between the rim 245 and the support surface 235 is a side surface 240 of the frame 215 that is designed to surround the peripheral edge portion 225 of the hand hole cover 205. The height of the side surface 240 and the peripheral edge portion 225 are substantially the same so that, when seated and engaged, the top surface 220 of the cover 205 is substantially flush with the rim 245 of the hand hole frame 215. Although shown as rectangle-shaped, it will be understood that the hand hole cover 205 and frame 215 can be of any suitable shape.

In accordance with the present invention, the hand hole cover 205 includes a lock aperture 270 in the top surface 220 for receiving the security locking device 10. The aperture 270 preferably extends through the cover 205 and through the bottom surface; however, the aperture only needs to be deep enough to fully receive the security locking device 10 therein and below the top surface 220. In a preferred embodiment, the hand hole cover 205 preferably includes at least one fixed locator bar 30 that extends laterally out from the peripheral edge portion 225 for insertion into a corresponding aperture 280 in the enclosure frame 215. If the hand hole cover 205 is hinged to the frame 215, then the fixed locator bar 30 is not needed. The hand hole cover 205 also includes a manual throw bolt 26 that fits and moves within an aperture that extends laterally within the cover 205 through the peripheral edge portion 225 and into the lock aperture 270. In a preferred embodiment, the fixed locator bar 30 is positioned on the opposed side of the cover 205 from the manual throw bolt 26. Further, although the fixed locator bar 30 and manual throw bolt 26 are shown in FIG. 2 as being disposed across from each other between the near rectangular edges of the cover 205, they could just as easily be disposed across from each other between the more distance rectangular edges of the cover 205. As will be described in greater detail hereinafter, the manual throw bolt 26 is designed to engage and fit within aperture 290 in the frame 215 when the cover 205 is in its seated position on the enclosure frame 215 and when the security locking device 10 is installed within the locking aperture 270. When the security locking device 10 is not installed within the locking aperture 270, the manual throw bolt 26 is designed to reciprocate or slide back into the locking aperture 270 space and, thus, to disengage from the aperture 290 in the frame 215 so that the cover 205 is no longer locked to the frame 215 and can be lifted and removed from seated engagement with the frame 215.

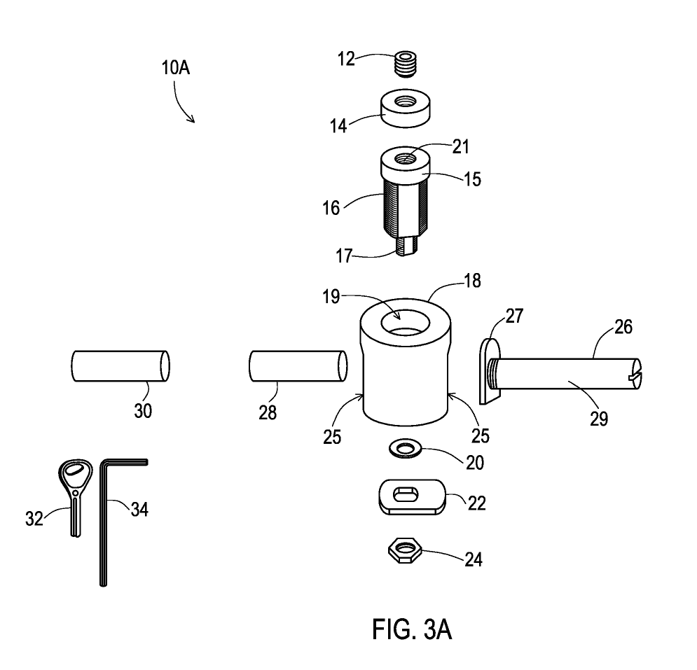

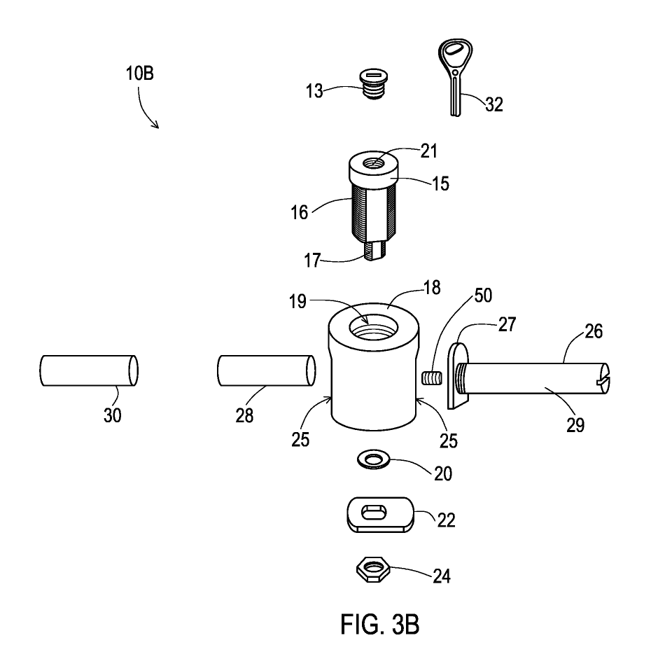

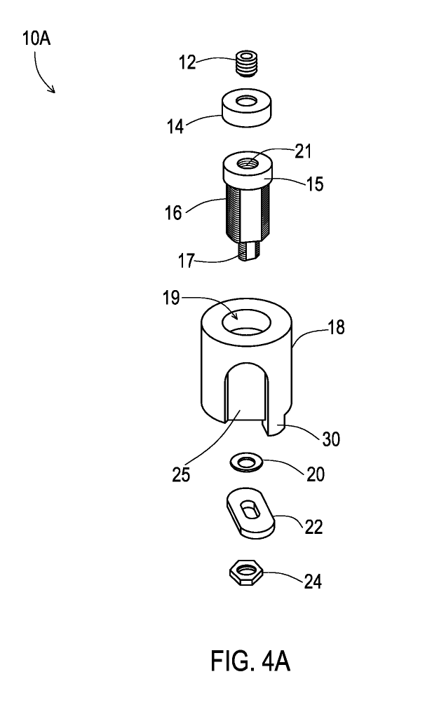

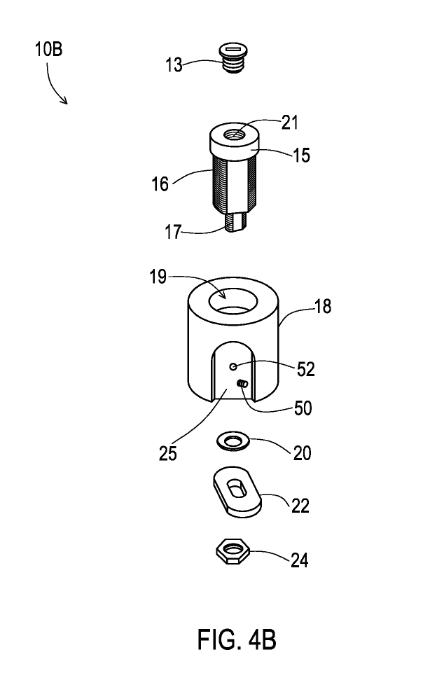

Referring now to FIGS. 3A, 3B, 4A, and 4B, exploded, perspective views of two different embodiments of the security locking device 10 are illustrated. FIGS. 3A and 3B illustrate the security locking device 10 in combination with the tools 32,34, bolt 26, and bars 28,30 that are added or retrofit into a conventional cover or lid in accordance with the teachings herein. FIGS. 4A and 4B illustrate just the security locking device 10 rotated a quarter turn to highlight one of the indents or saddle voids 25 formed within the lock housing 18 that are used to engage respective ends or tips of the bolt 26 and bar 28, as will be described in greater detail herein.

Turning now to FIGS. 3A and 4A, a first embodiment of a security locking device 10A is illustrated. The security locking device 10A includes a lock housing 18 having an aperture 19 extending therethrough to accept a cylinder cam lock 16. The top 15 of the cylinder cam lock 16 has a key hole 21 therein for receiving a standard key 32. The top 15 of the cylinder cam lock 16 preferably has a greater diameter than the lower portion of the cam lock. When the cylinder cam lock 16 is fully inserted, the top 15 is designed to rest upon a lip or ledge within the aperture 19 of the lock housing 18, which prevents the cylinder cam lock 16 from falling or being forced down too far through the aperture 19. The top of the lock housing 18 is also formed to accept a fitted retaining cap 14 after the cylinder cam lock 16 has been fully inserted within the aperture 19. The fitted retaining cap 14 is threaded to receive a threaded plug 12.

When the cylinder cam lock 16 is fully inserted, a bottom cam shaft 17 of the cylinder cam lock 16 extends through the bottom of the aperture 19 of the lock housing 18 so that a cam washer 20, a cam plate 22, and a cam hex nut 24 can be attached thereto. The cam plate 22 preferably extends below the bottom of the lock housing 18 so that, when turned in response to turning of the key 32 within the key hole 21, the cam plate 22 can be used to lock and unlock the security locking device 10 from the cover or lid by engaging the manual throw bolt 26, as will be described in greater detail hereinafter.

FIG. 3A also illustrates the key 32 used for locking and unlocking the cylinder cam lock 16, as described above, and the wrench 34 used to remove the threaded plug 12. If the cover is not hinged to its frame, a fixed locator bar 30 is preferably inserted into the cover or lid and extends laterally from the peripheral edge 125,225 of the cover, as was described above in greater detail with reference to FIGS. 1 and 2. An internal fixed positioning bar 28 is mounted into the cover or lid and is designed to extend partially into the lock aperture 170, 270 (shown in FIGS. 1 and 2). Alternatively, the fixed positioning bar 28 can be replaced by a mounting post, stop, or similar protrusion attached to or formed as part of the cover/lid that extends into the lock aperture 170,270 for engagement with one side of the lock housing 18 when inserted. On the opposed side of the lock aperture 170,270, the manual throw bolt 26 is designed to reciprocate or slide along a horizontal aperture within the cover extending between the lock aperture 170,270 and a side aperture 190,290, shown in FIGS. 1 and 2, respectively.

The manual throw bolt 26 preferable includes an engagement head or plate 27 screwed on or otherwise attached to the one end of the main shaft 29 of the throw bolt 26 that extends within the lock aperture 170,270. As shown more fully in FIG. 4A, the lock housing 18 has opposed indents 25 configured into each side of the body of the housing 18. One indent 25 is configured to receive the protruding end of the fixed positioning bar 28 and the other indent 25 is configured to receive the engagement head 27 of the manual throw bolt 26, when the lock housing 18 has been inserted into the aperture 170,270 of the cover or lid. Preferably, the protruding end of the fixed positioning bar 28 and the engagement head 27 are shaped to mate with the indents 25. A rounded or saddle shape form is preferred.

As shown in FIG. 4A, the lock housing 18 includes an optional range-limiting lip 30, which is designed to limit the rotation of the cam plate 22 and, thus, rotation of the cylinder cam lock 16 within the lock housing 18.

Preferably, when installed in a cover, the cam plate 22 can be rotated in response to turning of the key 32 within the key hole 21 which toggles the cam plate 22 between a locked position in which the cam plate 22 is below and engaged with the engagement head 27 of the manual throw bolt 26, which means that the shaft 29 of the manual throw bolt 26 is displaced by the lock housing 18 in the aperture 170,270 and therefore extends from the peripheral side of the cover and, preferably (assuming it is properly seated and placed), into locking position in its frame or enclosure. When the cam plate 22 is rotated with the key 32 to its unlocked position, the cam plate 22 is no longer below or engaged with the engagement head 27 of the manual throw bolt 26. When unlocked, the security locking device 10 can be easily removed from the aperture 170,270, which then provides ample space to retract the manual throw bolt 26 into the space previously occupied by the lock housing 18, which disengages the cover/lid from its frame/enclosure.

Preferably, the security locking device is configured so that the indents 25 of lock housing 18 rest on the distal or protruding end of the fixed positioning bar 28 and on the engagement head 27 of the manual throw bolt 26, which prevents excessive downward pressure on the lock housing 18 and lock 16, which would compromise the integrity of the lock. Conversely, when the cylinder cam lock 16 is locked with the key 32, the cam plate 22 turns and is secured below the engagement head 27 of the manual throw bolt 26, which restricts upward pressure and prevents unauthorized removal of the lock housing 18 and correspondingly prevents access to and reciprocation of the manual throw bolt 26 back into the locking aperture 170,270 of the cover/lid.

Preferably, as shown in FIG. 4A, to assemble the housing components, the cylinder cam lock 16 is inserted into the lock housing 18 and the cam washer 20, the cam plate 22, and the cam hex nut 24 are attached to the shaft 17 of the cylinder cam lock 16 below the lock housing 18. The fitted retaining cap 14 is pressed or threaded into the top of the lock housing 18 and the threaded plug 12 is screwed into the fitted retaining cap 14 to complete the assembly.

Turning now to FIGS. 3B and 4B, a second embodiment of a security locking device 10B is illustrated. The security locking device 10B is similar to the first embodiment 10A shown in FIGS. 3A and 3B with a few differences.

For example, rather than having a fitted retaining cap 14 that is pressed or threaded into the top of the lock housing 18 for receipt of the threaded plug 12, the security locking device 10B has a single, threaded cap 13 that is designed to fit on or screw into the top of the lock housing 18 above the top of the cylinder cam lock 16. Unlike the threaded plug 12 that tightened or untightened using wrench 34, threaded cap 13 is preferably tightened or untightened using a regular screw driver. One purpose of either the cap and plug 12,14 or the threaded cap 13 is to provide one layer of protection, albeit minimal, before an unauthorized individual would be able to access the key hole 21 of the cylinder cam lock 16. Another purpose of either the cap and plug 12,14 or the threaded cap 13 is to protect the cylinder cam lock 16 from weather and environmental conditions.

Further, the second security locking device 10B uses a set screw 50 inserted through screw hole 52 to enable the outside of the cylinder cam lock 16 to be locked into place within the lock housing 18. Use of set screw 50 helps keep the cylinder cam lock 16 from being inserted too far into the lock housing 18 and also help keep the cylinder cam lock 16 from rotating within the lock housing 18. Use of set screw 50 obviates the need for the range-limiting lip 30 used with the first security locking device 10A.

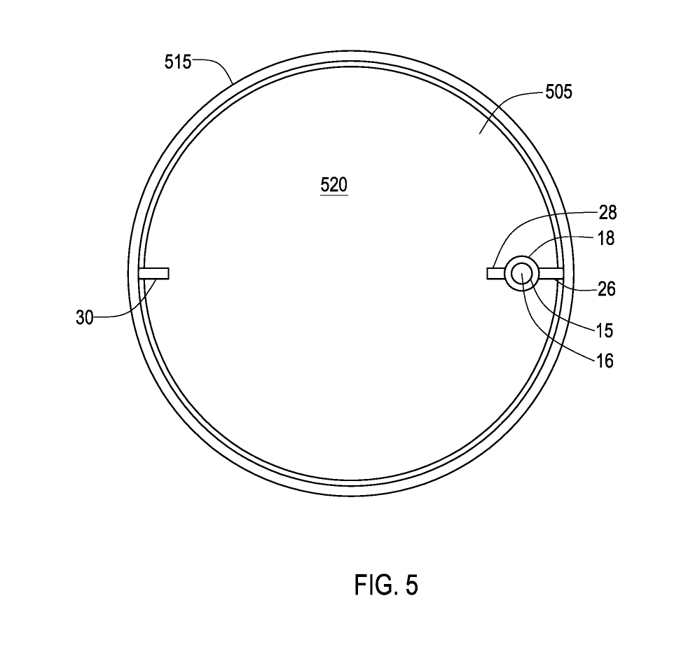

Turning now to FIG. 5, a top view of a manhole cover 505 locked onto a frame 515 using the security locking device and techniques of the present invention is illustrated. To prepare the enclosure cover/lid 505 for use with the security locking device 10, whether the cover/lid is being retrofit or whether the cover/lid is being manufactured initially for use with the security locking device 10. In either case, three round holes are drilled or otherwise formed in the cover/lid 505 to accept the security locking device 10. The first hole or aperture is sufficiently wide and sufficiently deep enough, located in the side of the enclosure cover 505, to receive the fixed locator bar 30. The second hole or aperture is also formed or located in the side of the enclosure cover 505, preferably on the opposite side of the enclosure cover 505. The second hole or aperture is sufficiently wide and sufficiently deep enough to accept the fixed positioning bar 28 and the manual throw bolt 26. The third hole is drilled or formed into the top surface 520 of the enclosure cover 505 and is sufficiently wide and sufficiently deep enough to accept the lock housing 18 and positioned so that the indents 25 of the lock housing 18 can be positioned over and rest on both the respective ends of the fixed positioning bar 28 and the manual throw bolt 26.

Still referring to FIG. 5, to retrofit and install the security locking device 10 into the enclosure cover 505, the fixed locator bar 30 is placed into the first round hole. Additional adhesives can be used to secure the fixed locator bar 30 if necessary. An end portion or tip of the fixed locator bar 30 extends from the peripheral edge of the cover 505 for locking insertion into a corresponding aperture in the frame 505. As stated previously, if the cover 505 is attached in a hinged manner to the frame 515 at this location, then use of the fixed locator bar 30 is unnecessary. Additionally, if the security locking device 10 is not being retrofit, the enclosure cover 505 can be formed with the fixed locator bar 30 integrated therein during original manufacture.

The fixed positioning bar 28 is placed into the second drilled hole positioned so that the fixed positioning bar 28 will accept one indent 25 of the lock housing 18. Additional adhesives can be used to secure the fixed positioning bar 28, if necessary. Thus, an end portion or tip of the fixed positioning bar 28 extends partially into the third hole or opening through the top surface 520 of the cover 505. This third hole corresponds with the apertures 170,270 from FIGS. 1 and 2. Additionally, if the security locking device 10 is not being retrofit, the enclosure cover 505 can be formed with the fixed positioning bar 28 integrated therein during original manufacture.

Finally, the shaft 29 of the manual throw bolt 26 is inserted into the enclosure cover 505 and the engagement head 27 of the manual throw bolt 26 is threaded onto or otherwise attached to the one end of the shaft 29 of the manual throw bolt 26 that extends into the third hole or opening through the top surface 520 of the cover 505 opposite the fixed positioning bar 28. The enclosure cover 505 is now ready to accept the lock housing 18.

Still referring to FIG. 5, to prepare the enclosure frame 515 to accept the enclosure cover 505 with the security locking device 10 installed, two holes are drilled or otherwise formed in the enclosure frame 505 sufficiently sized to accept the fixed locator bar 30 and the manual throw bolt 26. Because the fixed locator bar 30 and the manual throw bolt 26 are preferably disposed on opposite sides of the enclosure cover 505, the holes in the enclosure frame 515 should likewise be drilled on opposed sides of the enclosure frame 515 and should follow the mating size and configuration for receiving the extended portions of the fixed locator bar 30 and of the manual throw bolt 26 when the lock housing 18 has been inserted into the third hole through the surface of the cover 505. The holes drilled or formed into the enclosure frame 515 should be of a sufficient size (diameter/cross-section and depth) and at a sufficient height on the enclosure frame 515 so that the fixed locator bar 30 will fit securely into one aperture in the frame 515 and the manual throw bolt 26 will slide back and forth into locking and unlocking engagement within the other aperture in the frame 515 when the cover 505 is properly seated onto the frame 515.

As has been described above, preferred embodiments of the present invention include one fixed locator bar disposed on one side of the cover/lid and one retractable manual throw bolt on the opposed side of the cover/lid. It will be appreciated by those of skill in the art that multiple locator bars and/or multiple retractable manual locator bars (each associated with a corresponding security locking device) can be used—especially for covers/lids that require additional strength or security. For example, in one alternate embodiment (not illustrated), it may be desirable to have two security locking devices, each associated with a different key, installed and used with a particular cover or lid. Such security locking devices could be positioned on opposed sides of the cover/lid, thus, replacing the fixed locator bar. Alternatively, for a round or circular cover/lid, the hinge point or locator bar could be positioned at one location around the edge of the cover/lid and the two separate security locking devices could be disposed at positions 120 degrees apart from each other and from the hinge point/locator bar location. The variations of placement and the number of fixed bars and retractable bars used for any cover or lid are infinite and within the scope of the invention disclosed and described herein.

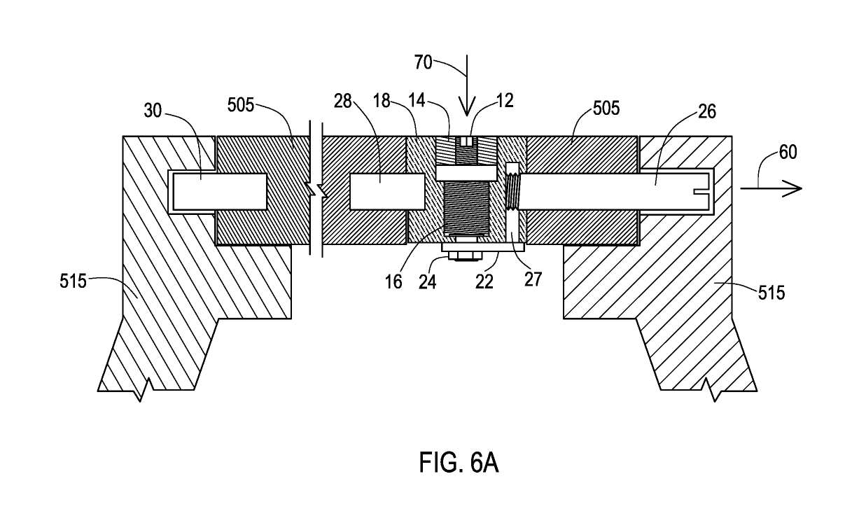

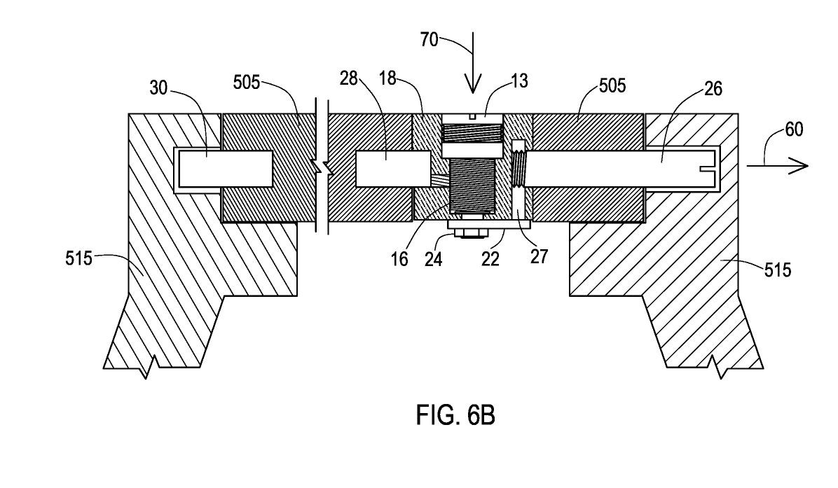

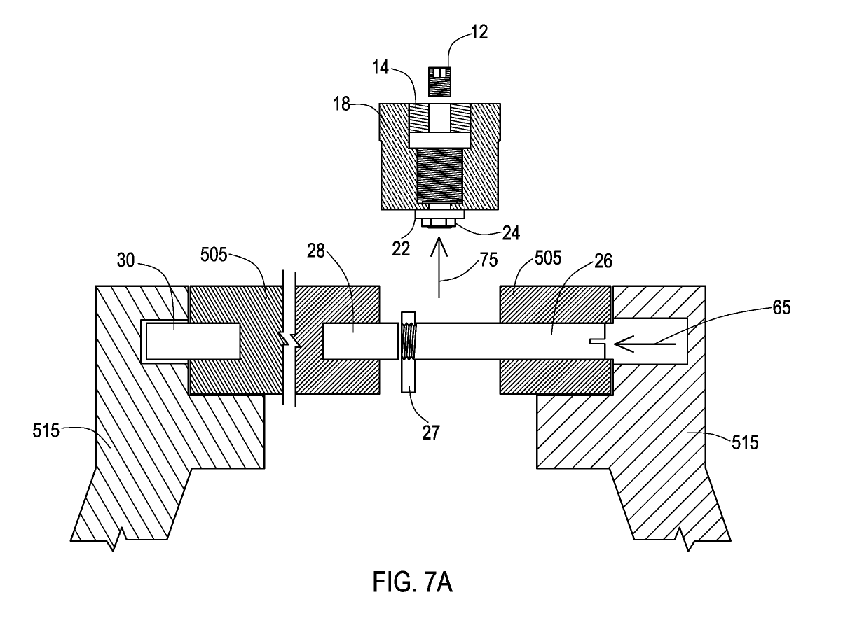

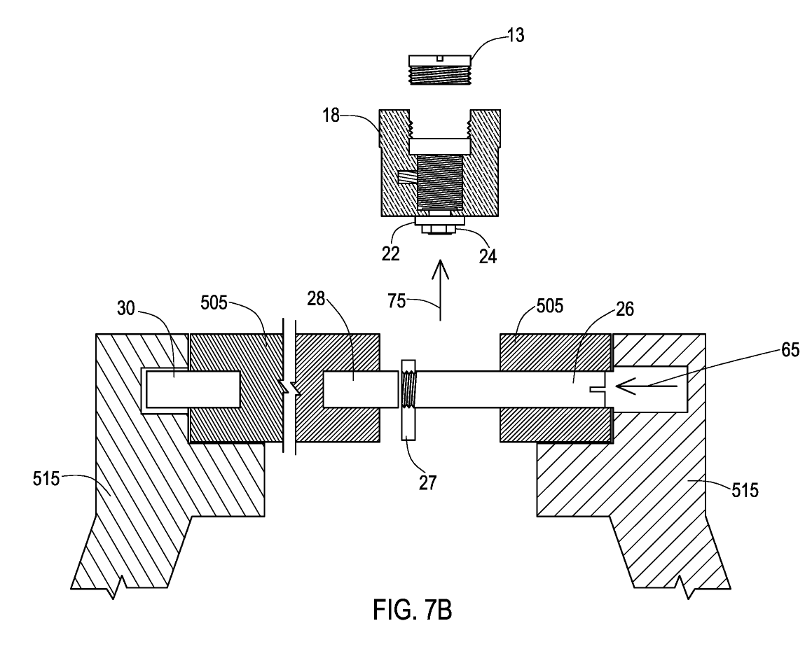

Now referring to FIGS. 6A, 6B, 7A, and 7B, cross sectional views of two different embodiments of the security locking device 10 are illustrated. FIGS. 6A and 6B illustrate the two different embodiments of the security locking device 10 in which each embodiment of the security locking device 10 is installed in the locked position 70 in the enclosure cover 505 and secured into the enclosure frame 515. The fixed locator bar 30 is inserted into the enclosure frame 515 and the manual throw bolt 26 is engaged into the enclosure frame 515 showing a locked and secure position 60. The lock housing 18 is locked and seated onto the fixed positioning bar 28 and the manual throw bolt 26. The cam plate 22 is in the locked position under the engagement head 27 of the manual throw bolt 26, which, along with the body of the lock housing 18, secures the manual throw bolt 26.

FIGS. 7A and 7B illustrate the two different embodiments of the security locking device 10 in which each embodiment of the security locking device 10 is shown removed from the enclosure cover 505 and in the unlocked position 75. The caps 12,14 or 13 have been removed and the cylinder cam lock 16 has been unlocked, which shifts the cam plate 22 ninety degrees, which moves the cam plate 22 into a position in which the cam plate 22 is no longer in a locked engagement position under the engagement head 27 of the manual throw bolt 26. This allows the lock housing 18 to be disengaged and removed from the enclosure cover 505. The lock housing 18 is shown removed 75 from the enclosure cover 505. The manual throw bolt 26 is shown in an unlocked position 65 in which the manual throw bolt 26 has been pulled back into the space vacated by the lock housing 18 and disengaged from the enclosure frame 515. When in this unlocked position, the enclosure cover 505 is either (i) in a position to be removed from the frame 515 to allow access to the space or enclosure protected by the enclosure cover 505 or (ii) in a position in which the enclosure cover 505 has just been returned into a seated position on the frame 515 and is now ready to have the manual throw bolt 26 moved into a locking position and held there by the security locking device 10 once it is inserted and locked back into place.

As will be appreciated by those of skill in the art, the lock housing 18, the threaded plug 12, the fitted retaining cap 14, the threaded cap 13, the fixed locator bar 30, the fixed positioning bar 28, the manual throw bolt 26, the cam washer 20, the cam plate 22, and the cam hex nut 24 may be made of stainless steel, aluminum, anodized aluminum, or of any other sufficiently rigid and strong material that will provide a level of deterrent to theft and vandalism, adequately resist corrosion, resist or deter electric current, if possible, and provide a level of resistance to impact disintegration when installed. The cylinder cam lock 16 is made, as sufficiently as possible, to withstand and deter attempts to gain unauthorized entry into the enclosure.

Components of the security locking device 10 may be cast, welded, formed, lathed, extracted, stamped, or cut for functionality, strength, durability, and resistance to corrosion.

The advantages of the above describe security locking device and system include, without limitation, that it has the functionality to lock or secure any lid, cover, door, or access panel of sufficient depth, with a standard-sized key that can be customized, zoned, and mastered and that can be retrofit into an existing lid with minimal alteration of the cover and frame. It also has the advantage of being able to be replaced without having to change or replace out the existing cover. Another advantage is that there are no springs, gears, or moving parts to corrode, break, or seize.

Yet further, the above described security locking device and system is easy to install both with initial construction or retrofit implementations. The modifications to an existing enclosure are minimized—requiring only two holes (or only one if the cover is hinged to the frame) in the enclosure frame that can be accomplished easily in the field.

Other advantages include keyed access to the enclosure while deterring unauthorized access to critical components, copper, and cabling. Further, the present invention locks the cover in place and deters theft of the cover itself—as most composite or polymer covers have no scrap value.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A locking apparatus for use with an enclosure cover, the enclosure cover adapted for seated engagement on an enclosure frame, the enclosure cover having a generally planar top surface, a generally planar bottom surface parallel to and disposed a fixed distance h from the top surface, the enclosure cover having a peripheral edge extending around the outer side of the enclosure cover between the top and bottom surface, the enclosure cover having a lock aperture extending perpendicularly through the top surface near an edge of the enclosure cover and a bar aperture extending laterally from the peripheral edge and into the lock aperture, the enclosure frame having a top ridge forming an opening for receipt of the enclosure cover, a support ledge disposed within the enclosure the distance h from the top ridge, the opening through the support ledge being smaller than the opening formed by the top ridge, the top ridge and the support ledge connected by a side member extending therebetween, a bar receiving aperture formed within the side member, so that when in seated engagement the outer edge of the bottom surface of the enclosure cover rests on the support ledge and the lock aperture of the enclosure cover is aligned with the bar receiving aperture in the side member of the enclosure frame, the locking apparatus comprising:
a lock housing shaped to fit within the lock aperture;
a mounting post connected to the enclosure cover and having a portion extending a fixed distance within the lock aperture, the portion of the mounting post extending within the lock aperture having an end, the lock housing having a first mounting indent on one side thereof for engagement with the end of the mounting post when the lock housing is inserted within the lock aperture;
a manual throw bolt inserted within the bar aperture, the manual throw bolt having a shaft extending between the peripheral edge of the enclosure cover and the end of the mounting post within the lock aperture, the shaft having one end extending within the lock aperture, wherein, when the lock housing is inserted within the lock aperture, the manual throw bolt is displaced substantially out of the lock aperture and the other end of the shaft extends into the bar receiving aperture of the enclosure frame, the lock housing having a second mounting indent on the side opposed to the first mounting indent for engagement with the one end of the shaft of the manual throw bolt when the lock housing is inserted within the lock aperture; and
a cylinder cam lock mounted within the lock housing, the cam lock having a key hole for receipt of a key configured for use with the cylinder cam lock, the key hole positioned on top of the cylindrical cam lock and accessible through the top surface of the enclosure cover, the cam lock having a cam shaft extending longitudinally through and beyond a bottom surface of the lock housing, a cam plate attached to the end of the cam shaft extending beyond the bottom surface of the lock housing, the cam shaft and cam plate rotatable between a locked position and an unlocked position in response to rotation of the key in the key hole;
wherein, when in the locked position, the cam plate is positioned below the one end of the shaft of the manual throw bolt, thereby preventing the lock housing from being removed from the lock aperture, which maintains the other end of the shaft in locking engagement within the bar receiving aperture of the enclosure frame, which prevents the edge of the enclosure cover from being lifted from the enclosure frame.

2. The locking apparatus of claim 1 wherein the lock aperture extends through the bottom surface of the enclosure cover.

3. The locking apparatus of claim 2 wherein engagement of the first mounting indent on the end of the mounting post and engagement of the second mounting indent on the one end of the shaft of the manual throw bolt prevents the lock housing from being forced too far into the lock aperture.

4. The locking apparatus of claim 1 wherein the first and second mounting indents of the lock housing are shaped to mate, respectively, with the end of the mounting post and the one end of the shaft of the manual throw bolt.

5. The locking apparatus of claim 4 wherein the first and second mounting indents of the lock housing are rounded or saddle-shaped.

6. The locking apparatus of claim 1 wherein the lock aperture and the lock housing are cylindrical.

7. The locking apparatus of claim 1 wherein the lock aperture and the lock housing are non-cylindrical.

8. The locking apparatus of claim 1 wherein the one end of the manual throw bolt is a removable plate.

9. The locking apparatus of claim 1 wherein the cylindrical cam lock is removably mounted within the lock housing and held in place using a set screw.

10. The locking apparatus of claim 1 wherein the cylindrical cam lock is fixedly mounted within the lock housing.

11. The locking apparatus of claim 1 wherein, when the cam plate is in the unlocked position, the cam plate is no longer positioned below the one end of the shaft of the manual throw bolt thereby enabling the lock housing to be removed from the lock aperture and enabling the shaft of the manual throw bolt to be withdrawn from the bar receiving aperture of the enclosure frame thereby enabling the enclosure cover to be lifted from the enclosure frame.

12. The locking apparatus of claim 1 wherein a cap is placed within the top of the lock housing to cover and protect the key hole and top portion of the cylinder cam lock and wherein the top of the lock housing and the cap are flush with the top surface of the enclosure cover.

13. The locking apparatus of claim 1 wherein the key is a standard-sized door key.

14. The locking apparatus of claim 1 wherein the cylinder cam lock is configured for use with a zoned or master key.

15. The locking apparatus of claim 1 wherein the enclosure cover is further engaged with the enclosure frame on the opposed edge of the enclosure cover opposite the lock aperture.

16. The locking apparatus of claim 15 wherein the enclosure cover is engaged with the enclosure frame using a positioning bar extending laterally from the peripheral edge of the enclosure cover and into a positioning bar aperture formed within the enclosure frame.

17. The locking apparatus of claim 15 wherein the enclosure cover is engaged with the enclosure frame using a hinge.

18. The locking apparatus of claim 15 wherein the enclosure cover is engaged with the enclosure frame using a second manual throw bolt locked using a second cylinder cam lock inserted into a second lock aperture.

19. The locking apparatus of claim 1 wherein the bar aperture is positioned a height x above the bottom surface of the enclosure cover and the bar receiving aperture is formed within the side member of the enclosure frame at the corresponding height x above the support ledge.

20. An integrated enclosure cover and locking apparatus, the enclosure cover adapted for seated engagement on an enclosure frame, the enclosure frame having a top ridge forming an opening for receipt of the enclosure cover, a support ledge disposed within the enclosure a distance h from the top ridge, the opening through the support ledge being smaller than the opening formed by the top ridge, the top ridge and the support ledge connected by a side member extending therebetween, the enclosure frame further including a bar receiving aperture formed within the side member, the integrated enclosure cover and locking apparatus comprising:
an enclosure cover housing, the enclosure cover housing having a generally planar top surface, a generally planar bottom surface parallel to and disposed a fixed distance h from the top surface, and a peripheral edge extending around the outer side of the enclosure cover between the top and bottom surface, the enclosure cover housing having a lock aperture extending perpendicularly through the top surface near an edge of the enclosure cover housing and a bar aperture extending laterally within the enclosure cover housing from the peripheral edge and into the lock aperture, the enclosure cover housing shaped so that, when in seated engagement with the enclosure frame, the outer edge of the bottom surface of the enclosure cover housing rests on the support ledge and the lock aperture is aligned with the bar receiving aperture in the side member of the enclosure frame;
a lock housing shaped to fit within the lock aperture;
a mounting post connected to the enclosure cover housing and having a portion extending a fixed distance within the lock aperture, the portion of the mounting post extending within the lock aperture having an end, the lock housing having a first mounting indent on one side thereof for engagement with the end of the mounting post when the lock housing is inserted within the lock aperture;
a manual throw bolt inserted within the bar aperture, the manual throw bolt having a shaft extending between the peripheral edge of the enclosure cover housing and the end of the mounting post within the lock aperture, the shaft having one end extending within the lock aperture, wherein, when the lock housing is inserted within the lock aperture, the manual throw bolt is displaced substantially out of the lock aperture and the other end of the shaft extends into the bar receiving aperture of the enclosure frame, the lock housing having a second mounting indent on the side opposed to the first mounting indent for engagement with the one end of the shaft of the manual throw bolt when the lock housing is inserted within the lock aperture; and
a cylinder cam lock mounted within the lock housing, the cam lock having a key hole for receipt of a key configured for use with the cylinder cam lock, the key hole positioned on top of the cylindrical cam lock and accessible through the top surface of the enclosure cover housing, the cam lock having a cam shaft extending longitudinally through and beyond a bottom surface of the lock housing, a cam plate attached to the end of the cam shaft extending beyond the bottom surface of the lock housing, the cam shaft and cam plate rotatable between a locked position and an unlocked position in response to rotation of the key in the key hole;
wherein, when in the locked position, the cam plate is positioned below the one end of the shaft of the manual throw bolt, thereby preventing the lock housing from being removed from the lock aperture, which maintains the other end of the shaft in locking engagement within the bar receiving aperture of the enclosure frame, which prevents the edge of the enclosure cover housing from being lifted from the enclosure frame.
